(19) United States
(12) Patent Application Publication
(10) Pub. No.: US 2026/0164125 A1
(43) Pub. Date: Jun. 11, 2026

(54) LENS SYSTEM, LENS CONTROL METHOD, AND LENS CONTROL PROGRAM

(71) Applicant: Tamron Co., Ltd., Saitama (JP)

(72) Inventor: Tomoharu SAITO, Saitama (JP)

(73) Assignee: Tamron Co., Ltd., Saitama (JP)

(21) Appl. No.: 19/334,223

(22) Filed: Sep. 19, 2025

(30) Foreign Application Priority Data
Dec. 5, 2024 (JP) 2024-212479

(51) Int. Cl. H04N 23/67; H04N 23/62

(52) U.S. Cl. CPC H04N 23/67; H04N 23/62

(57) ABSTRACT

A lens system for generating a set of still images, which includes: a lens optical system; a memory that stores setting information regarding imaging conditions; and a processor, in which the processor executes repetitive driving processing of causing the lens optical system to repeat driving between imaging and stopping and holding during imaging based on the setting information, and continuous stopping processing of causing the lens optical system to continue stopping and holding during a plurality of times of imaging based on the setting information.

### CROSS-REFERENCE TO RELATED APPLICATIONS

This application is based on and claims the benefit of priority from Japanese Patent Application No. 2024-212479, filed on Dec. 5, 2024, the entire contents of which are incorporated herein by reference.

### BACKGROUND OF THE INVENTION

### Technical Field

The present disclosure relates to a lens system, a lens control method, and a lens control program.

### Related Art

Through wide spread of social networking services (SNSs) for posting moving images, such as TikTok (registered trademark) and Instagram (registered trademark), there is a tendency of a rapid increase in demand for producing moving images that make it possible to guide a line of sight of a viewer, and for producing creative still images. Such a tendency is also observed in time-lapse imaging and other imaging areas.

In addition to a normal moving image that is a set of still images continuously captured each at a time interval of 1/24 seconds, 1/30 seconds, 1/60 seconds, or 1/120 seconds, for example, among moving images, a time-lapse moving image that is continuously captured at a time interval longer than a time interval of such a normal moving image exists. JP H3-006543A and JP 2010-282079A disclose example techniques regarding continuous imaging of the latter. JP H3-006543A discloses an auto-zoom blanketing apparatus for a camera, which includes: an imaging lens; a setter that sets in advance a plurality of focal distances at which imaging takes place with the imaging lens; and a changer that sequentially changes a focal distance of the imaging lens to each of the plurality of set focal distances. JP 2010-282079A discloses an imaging apparatus that stores a moving range of a focus lens for allowing an imaging optical system to be focused on a subject and performs imaging while sequentially moving the focus lens to each of a plurality of target positions within the moving range without detecting a focused state, for example.

There is a tendency that moving images and still images are further required to have an ability of guiding the line of sight and to have creativity, and there is a demand for development of a new imaging technique for generating a set of still images that are possible to be utilized for producing such moving images and still images.

An object of one aspect of the present disclosure is to provide a new imaging technique for generating a set of still images.

### SUMMARY OF THE INVENTION

To solve such issues as described above, a lens system according to one aspect of the present disclosure is a lens system for generating a set of still images through continuous imaging in which imaging of still images is repeated, the lens system including: a lens optical system; at least one memory that stores setting information regarding imaging conditions; and at least one processor, in which the at least one processor executes, in the continuous imaging: repetitive driving processing of causing the lens optical system to repeat driving between imaging and stopping and holding during imaging based on the setting information; and continuous stopping processing of causing the lens optical system to continue stopping and holding during a plurality of times of imaging based on the setting information at least either before or after the repetitive driving processing.

To solve such issues as described above, a lens control method according to one aspect of the present disclosure is a lens control method for generating a set of still images through continuous imaging in which imaging of still images is repeated, the lens control method including, in a lens system including: a lens optical system; at least one memory that stores setting information regarding imaging conditions; and at least one processor, allowing the at least one processor to execute, in the continuous imaging: repetitive driving processing of causing the lens optical system to repeat driving between imaging and stopping and holding during imaging based on the setting information; and continuous stopping processing of causing the lens optical system to continue stopping and holding during a plurality of times of imaging based on the setting information at least either before or after the repetitive driving processing.

To solve such issues as described above, a lens control program according to one aspect of the present disclosure is a lens control program for controlling a lens system for generating a set of still images through continuous imaging in which imaging of still images is repeated, the lens system including: a lens optical system; at least one memory that stores setting information regarding imaging conditions; and at least one processor, the lens control program allowing the at least one processor to execute, in the continuous imaging: repetitive driving processing of causing the lens optical system to repeat driving between imaging and stopping and holding during imaging based on the setting information; and continuous stopping processing of causing the lens optical system to continue stopping and holding during a plurality of times of imaging based on the setting information at least either before or after the repetitive driving processing.

According to the aspects of the present disclosure, a new imaging technique for generating a set of still images is provided.

### BRIEF DESCRIPTION OF THE DRAWINGS

FIG. 1 is a block diagram illustrating a configuration of a lens system according to a first embodiment of the present disclosure;

FIG. 2 is a graph illustrating, as an outline of continuous imaging that the lens system illustrated in FIG. 1 executes, a relationship between a cumulative number of times of imaging and a focus position in continuous imaging;

FIG. 3 is a block diagram illustrating configurations of pieces of setting information stored in a memory of a lens and a memory of a camera illustrated in FIG. 1;

FIG. 4 is a flowchart illustrating a flow of control processing of continuous imaging, which the lens system illustrated in FIG. 1 executes;

FIG. 5 is a flowchart illustrating a flow of storage processing using the lens illustrated in FIG. 1;

FIG. 6 is a flowchart illustrating a flow of storage processing of first setting information, second setting information, and third setting information using an operation terminal illustrated in FIG. 1;

FIG. 7 is a schematic diagram illustrating screens that a touch display illustrated in FIG. 1 displays in the storage processing illustrated in FIG. 6;

FIG. 8 is a block diagram illustrating a configuration of a lens system according to a modification example of the first embodiment of the present disclosure;

FIG. 9 is a schematic diagram illustrating a screen that a touch display illustrated in FIG. 8 displays;

FIG. 10 is a flowchart illustrating a flow of control processing of continuous imaging, which the lens system illustrated in FIG. 8 executes;

FIG. 11 is a graph illustrating a modification example of the relationship between the cumulative number of times of imaging and the focus position in the continuous imaging illustrated in FIG. 3;

FIG. 12 is a graph illustrating a modification example of the relationship between the cumulative number of times of imaging and the focus position in the continuous imaging illustrated in FIG. 3;

FIG. 13 is a block diagram illustrating a configuration of a lens system according to a second embodiment of the present disclosure; and

FIG. 14 is a flowchart illustrating a flow of control processing of continuous imaging, which the lens system illustrated in FIG. 13 executes.

### DESCRIPTION OF THE EMBODIMENTS

### First Embodiment

Hereinafter, a first embodiment, which is an embodiment of the present disclosure, will be described in detail.

### (Lens System 100)

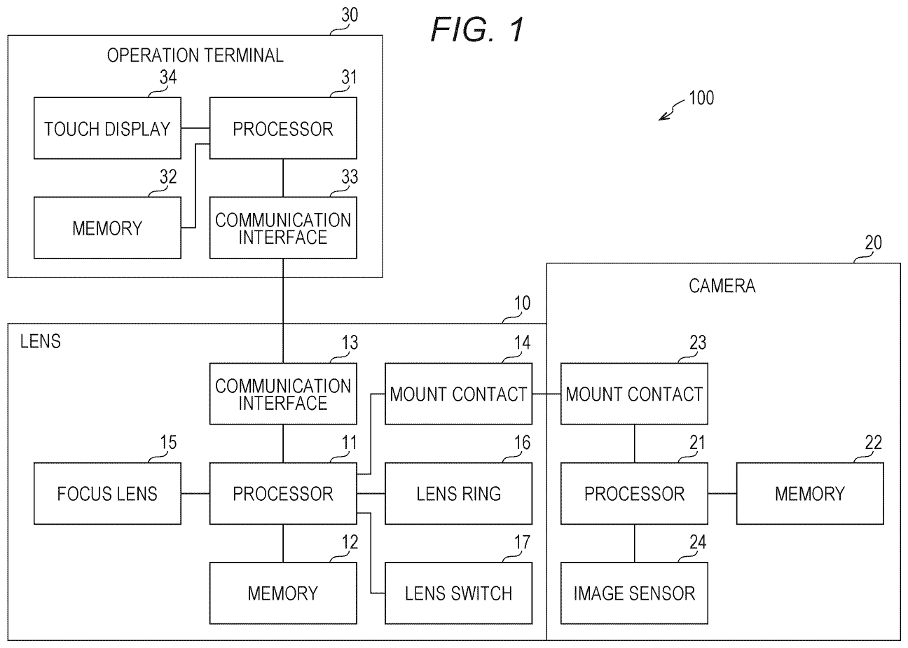

A configuration of a lens system 100 according to the first embodiment of the present disclosure will be described with reference to FIG. 1. FIG. 1 is a block diagram illustrating the configuration of the lens system 100 according to the first embodiment of the present disclosure. The lens system 100 is a system for controlling a lens optical system for generating a set of still images through continuous imaging in which imaging of still images is repeated. In the present specification, the “lens optical system” refers to a unit including at least one single lens and a support member that is coupled to the at least one single lens and that is capable of performing driving and stopping and holding. As the support member performs driving or stopping and holding in the lens optical system, the lens optical system is changed or kept in state. In the present disclosure, stopping and holding that the support member performs may be achieved as a processor transmits, to the support member, a signal instructing the support member to perform stopping and holding, and the support member follows the instruction to perform stopping and holding. In this case, the processor transmits, to the support member, a signal instructing stopping and holding to be performed to execute continuous stopping processing described later. Alternatively, in the present disclosure, stopping and holding that the support member performs may be achieved as the processor stops transmission, to the support member, of a signal instructing driving to be performed, and thus the support member does not perform driving but performs stopping and holding. In this case, the processor stops transmission, to the support member, of a signal instructing driving to be performed to execute the continuous stopping processing described later.

As illustrated in FIG. 1, the lens system 100 includes a lens 10, a camera 20, and an operation terminal 30. In the present embodiment, the lens 10 and the camera 20 are communicably coupled to each other via a mount contact 14 of the lens 10 and a mount contact 23 of the camera 20. The lens 10 and the operation terminal 30 are communicably coupled to each other using a universal serial bus (USB) cable via a communication interface 13 of the lens 10 and a communication interface 33 of the operation terminal 30.

In the present embodiment, mount communications and wired communications using the USB cable are adopted as methods of communications between the lens 10 and the camera 20 and between the lens 10 and the operation terminal 30, respectively. However, methods of communications in the present disclosure are not limited to those described above, and it is possible to adopt desired methods of communications, which enable electric communications. With a method of communications, the respective components may be directly coupled to each other, or may be indirectly coupled to each other via a network.

### (Lens 10)

The lens 10 is a configuration for forming an image of a subject on an image sensor 24 that the camera 20 includes. In the present embodiment, a lens barrel detachably attached to the camera 20 is adopted as the lens 10. As illustrated in FIG. 1, the lens 10 includes a processor 11, a memory 12, the communication interface 13, the mount contact 14, a focus lens 15, a lens ring 16, and a lens switch 17.

The processor 11 is a configuration for wholly controlling the lens 10 in operation. The processor 11 develops, on the memory 12, and executes a control processing program P10 stored in the memory 12 of the lens 10 in a non-volatile manner, and receives a notification from the processor 21 of the camera 20 to execute control processing of the lens 10. In the present embodiment, a central processing unit (CPU) is adopted as the processor 11. The control processing executed by the processor 11 will be described below while changing the drawings referred to.

The memory 12 is a computer-readable storage medium for storing various types of information regarding control of the lens system 100. In the present embodiment, the memory 12 stores, in a non-temporal manner, the control processing program P10 (a lens control program) of the lens 10, and stores setting information regarding imaging conditions. The setting information that the memory 12 stores will be described later while changing the drawings referred to. In the present embodiment, a combination of a dynamic random access memory (DRAM) serving as a primary memory and a flash memory serving as a secondary memory is adopted as the memory 12.

The communication interface 13 is a configuration for controlling transmission and reception of various types of information from the lens 10 and by the lens 10. In the present embodiment, a USB interface is adopted as the communication interface 13.

The mount contact 14 is a configuration for controlling transmission and reception of various types of information from the lens 10 and by the lens 10 through mount communications.

The focus lens 15 is a configuration for forming an image on the image sensor 24 of the camera 20. In the present embodiment, a combination of a single lens and a motor that is coupled to the single lens and that is capable of performing driving and stopping and holding is adopted as the focus lens 15. When the motor performs driving, the single lens moves along an optical axis, and a focus position (also referred to as a focusing position) of the lens optical system changes. The focus lens 15 is an example of a lens optical system in the present disclosure. The focus position is an example of a state of the lens optical system in the present disclosure.

The lens ring 16 is provides as an input unit, and is a configuration for receiving an input that a user provides for causing the focus lens 15 to perform driving. As an operation of the user is received, the lens ring 16 transmits a signal corresponding to an amount of the operation and a direction of the operation to the processor 11. The processor 11 causes the motor of the focus lens 15 to perform driving in accordance with the received signal to change the focus position.

The lens switch 17 is provided as an input unit, and is a configuration for receiving an input that the user provides for storing setting information in the memory 12. Processing using the lens switch 17 will be described later while changing the drawings referred to.

### (Camera 20)

The camera 20 is provided as an imaging unit, and is a configuration for converting the image of the subject, which has been formed on the image sensor 24, into an image. In the present embodiment, a camera body of a digital camera is adopted as the camera 20. As illustrated in FIG. 1, the camera 20 includes a processor 21, a memory 22, the mount contact 23, and the image sensor 24.

The processor 21 is a configuration for wholly controlling the camera 20 in operation. The processor 21 develops, on the memory 22, and executes a control processing program P20 stored in the memory 22 of the camera 20 in a non-volatile manner, and executes control processing of the camera 20. In the present embodiment, a CPU is adopted as the processor 21. The control processing executed by the processor 21 will be described below while changing the drawings referred to.

The memory 22 is a computer-readable storage medium for storing various types of information regarding control of the lens system 100 and image information that the processor 21 converts. In the present embodiment, the memory 22 stores, in a non-temporal manner, the control processing program P20 of the camera 20, and stores setting information regarding imaging conditions. The setting information that the memory 22 stores will be described later while changing the drawings referred to. In the present embodiment, a combination of a DRAM serving as a primary memory and a flash memory serving as a secondary memory is adopted as the memory 22.

The mount contact 23 is a configuration for controlling transmission and reception of various types of information from the camera 20 and by the camera 20 through mount communications.

The image sensor 24 is a photoelectric conversion element disposed around a position where an image of a subject is formed on the optical axis of the focus lens 15. In the present embodiment, a charge-coupled device (CCD) image sensor is adopted as the image sensor 24.

### (Operation Terminal 30)

The operation terminal 30 is a configuration for receiving an input that the user provides, regarding various types of information that the lens system 100 refers to. In the present embodiment, a smartphone is adopted as the operation terminal 30. As illustrated in FIG. 1, the operation terminal 30 is separated from the lens 10, and includes a processor 31, a memory 32, the communication interface 33, and a touch display 34.

The processor 31 is a configuration for wholly controlling the operation terminal 30 in operation. The processor 31 develops, on the memory 32, and executes a control processing program P30 stored in the memory 32 of the operation terminal 30 in a non-volatile manner, and executes control processing of the operation terminal 30. In the present embodiment, a CPU is adopted as the processor 31. The control processing executed by the processor 31 will be described below while changing the drawings referred to.

The memory 32 is a computer-readable storage medium for storing various types of information regarding control of the lens system 100. In the present embodiment, the memory 32 stores, in a non-temporal manner, the control processing program P30 of the operation terminal 30. In the present embodiment, a combination of a DRAM serving as a primary memory and a flash memory serving as a secondary memory is adopted as the memory 32.

The communication interface 33 is a configuration for controlling transmission and reception of various types of information from the operation terminal 30 and by the operation terminal 30. In the present embodiment, a USB interface is adopted as the communication interface 33.

The touch display 34 is provided as an input unit, and is a configuration for displaying a user interface (UI) for allowing the user to input an operation and for receiving an input that the user provides. In the present embodiment, an electronic component in which a display that displays a UI for allowing the user to input setting information and a touch sensor that detects a touch operation that the user inputs are integrally combined is adopted as the touch display 34.

### (Outline of Continuous Imaging)

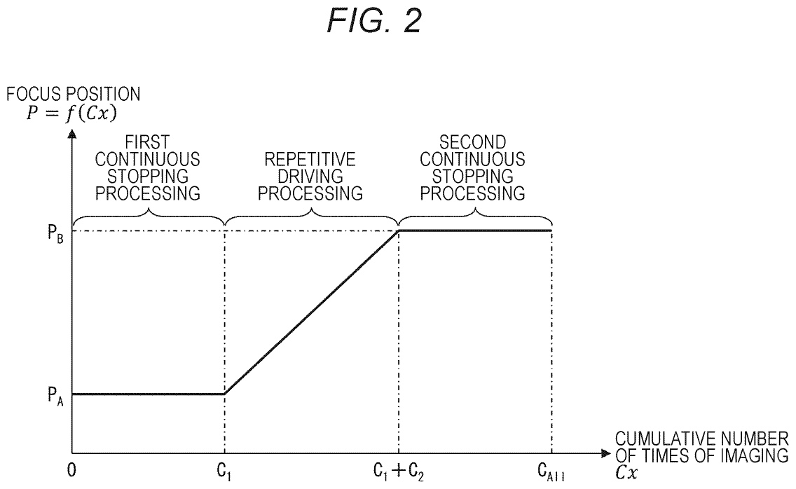

An outline of continuous imaging will be described with reference to FIG. 2. FIG. 2 is a graph illustrating, as the outline of the continuous imaging that the lens system 100 illustrated in FIG. 1 executes, a relationship between a cumulative number of times of imaging Cx and a focus position P in continuous imaging.

In the lens system 100, the camera 20 repeats imaging of still images at regular time intervals (continuous imaging). On the other hand, the lens 10 causes the focus lens 15 to perform driving and stopping and holding between and during imaging by the camera 20 to change or keep the focus position P. In the present embodiment, the lens system 100 executes, in continuous imaging:
repetitive driving processing in which the focus lens 15 repeats driving between imaging and stopping and holding during imaging to continuously perform imaging while changing the focus position P; and
continuous stopping processing in which the focus lens 15 is continuously stopped and held during a plurality of times of imaging to continuously perform imaging while the focus position P is kept constant at least either before or after the repetitive driving processing.

When continuous imaging is started, in the present embodiment, as illustrated in FIG. 2, first continuous stopping processing of repeating imaging of still images C₁ times while the focus position P is kept constant at a first focus position P_{A} is first executed. Next, repetitive driving processing of repeating imaging of still images C₂ times while the focus position P is changed from the first focus position P_{A} to a second focus position P_{B} is executed. Finally, second continuous stopping processing of repeating imaging of still images (C_{All}−(C₁+C₂)) times while the focus position P is kept constant at the second focus position P_{B} is executed.

In the present embodiment, the relationship between the focus position P and the cumulative number of times of imaging Cx is defined by a function f described below, which includes the focus position P as an objective variable and the cumulative number of times of imaging Cx as an explanatory variable that changes during continuous imaging.

$$\begin{matrix}f ( Cx ) = {P}_{A} & if Cx ≦ {C}_{1}\end{matrix} \qquad [ Mathematical Expression 1 ]$$

$$f ( Cx ) = {P}_{A} + \frac{( {P}_{B} - {P}_{A} )}{{C}_{2}} \times ( Cx - {C}_{1} ) \qquad if {C}_{1} < Cx ≦ {C}_{1} + {C}_{2}$$

$$f ( Cx ) = {P}_{B} \qquad if {C}_{1} + {C}_{2} < Cx$$

The function f further includes C₁, C₂, P_{A}, and P_{B} as explanatory variables fixed to be constant during continuous imaging. As setting information regarding imaging conditions, C₁, C₂, P_{A}, and P_{B} are stored in either the memory 12 of the lens 10 or the memory 22 of the camera 20.

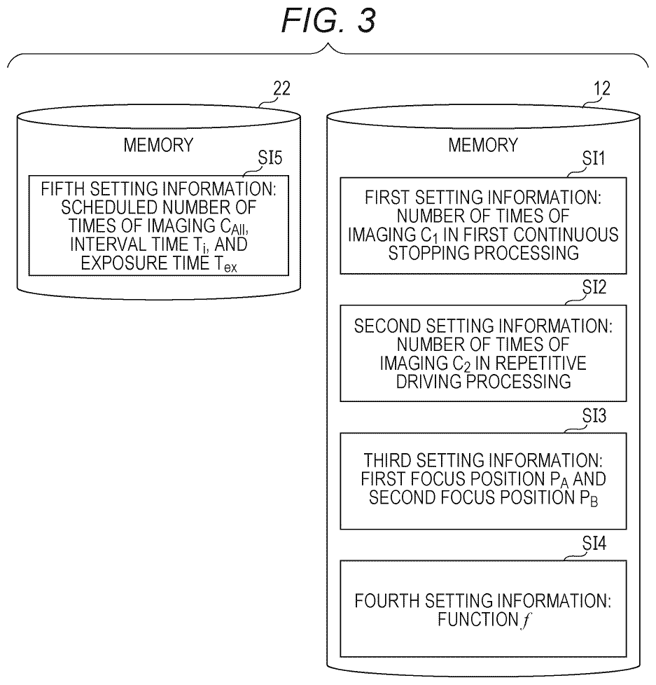

Setting information regarding imaging conditions will be described with reference to FIG. 3. FIG. 3 is a block diagram illustrating configurations of pieces of setting information stored in the memory 12 of the lens 10 and the memory 22 of the camera 20 illustrated in FIG. 1.

As illustrated in FIG. 3, the memory 12 of the lens 10 stores, as setting information regarding imaging conditions, first setting information SI1, second setting information SI2, third setting information SI3, and fourth setting information SI4. The memory 12 of the camera 20 stores, as setting information regarding imaging conditions, fifth setting information SI5. The processor 11 of the lens 10 refers to the first setting information SI1 to the fourth setting information SI4. The processor 21 of the camera 20 refers to the fifth setting information SI5.

The first setting information SI1 is information regarding continuation conditions of the continuous stopping processing. In the present embodiment, the first setting information SI1 includes a number of times of imaging C₁ in the first continuous stopping processing. However, the present disclosure is not limited to this configuration, and the first setting information SI1 may include duration of the continuous stopping processing.

The second setting information SI2 is information regarding continuation conditions of the repetitive driving processing. In the present embodiment, the second setting information SI2 includes a number of times of imaging C₂ in the repetitive driving processing. However, the present disclosure is not limited to this configuration, and the second setting information SI2 may include duration of the repetitive driving processing.

The third setting information SI3 is information regarding a driving amount of the lens optical system in the repetitive driving processing. In the present embodiment, the third setting information SI3 includes the first focus position P_{A} and the second focus position P_{B} as information regarding a state of the lens optical system at at least either a start time point or an end time point of the repetitive driving processing. In the present disclosure, as a state of the lens optical system, which is included in the third setting information SI3, there may be two or more different states or may be one state, that is, for example, only the first focus position P_{A}.

The fourth setting information SI4 is information regarding the function f that defines a relationship between a cumulative number of times of imaging or a cumulative period of time of imaging in continuous imaging and the state of the lens optical system. In the present embodiment, the fourth setting information SI4 includes the function f that defines the relationship between the focus position P and the cumulative number of times of imaging Cx. Specific content of the function f in the present embodiment is as described above.

The fifth setting information SI5 is information regarding operation of the image sensor 24 in continuous imaging. In the present embodiment, the fifth setting information SI5 includes a scheduled number of times of imaging C_{All}, an interval time Tᵢ, and an exposure time Tₑₓ.

Note that the present disclosure is not limited to such a configuration that a focus position is changed as described in the present embodiment, and the state of the lens optical system, which is to be changed, may be a desired state regarding imaging. Other example types of the state of the lens optical system include an aperture ratio of a diaphragm and a zoom magnification. It may be sufficient that the lens 10 includes a lens optical system that is drivable in accordance with a type of the state of the lens optical system, which is desired to be changed. As an example, the lens 10 may include either a diaphragm or a zoom lens.

In the present disclosure, there may be one type or two or more types of the state of the lens optical system, which changes. As an example, such a configuration that the focus position and the aperture ratio of the diaphragm change in conjunction with each other may be adopted.

### (Form of Continuous Imaging)

In the present embodiment, the lens system 100 is used for time-lapse imaging. In other words, a set of still images generated as a result of continuous imaging is utilized for producing a time-lapse moving image displayed in such a manner that frames of the plurality of still images are fed one by one.

However, utilization of a set of still images is not limited for time-lapse imaging, in the present disclosure, and is possible for a desired application. Continuous imaging may be executed, for example, as multiple exposure imaging. At this time, a set of still images generated as a result of continuous imaging is utilized for producing one still image in which a plurality of still images are composed with each other. Note herein that a mode of composition for producing a still image is optional, and is comparative bright composition as an example. As an example, a subject that is moving, as viewed from the camera 20, such as a celestial body, may be imaged through multiple exposure imaging using the lens system 100 according to the present embodiment. At this time, it is possible to produce a unique still image in which an image of a subject that is focused on and an image of a subject that is not focused on are separately shown.

### (Control Processing of Continuous Imaging)

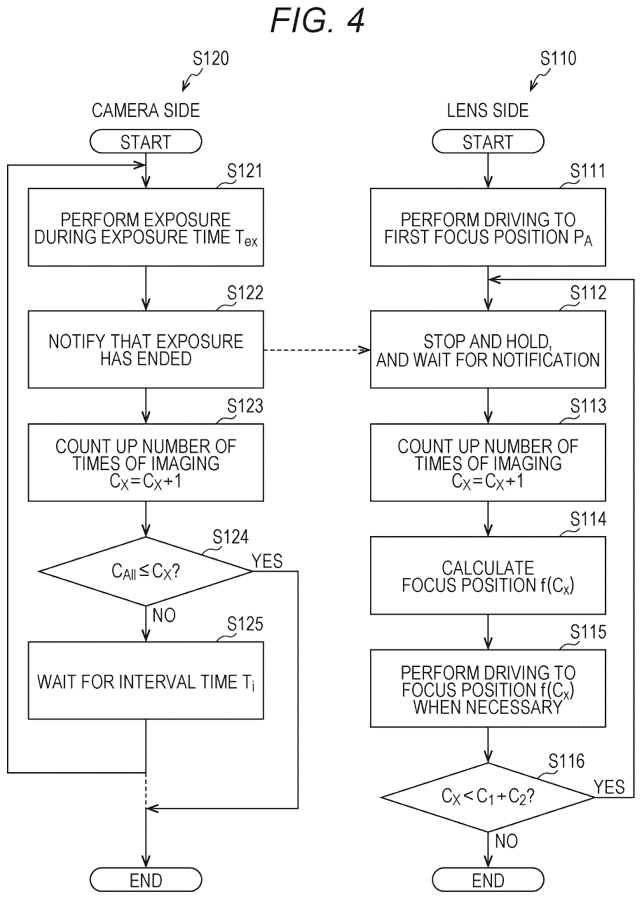

Details of control processing of continuous imaging will be described with reference to FIG. 4. FIG. 4 is a flowchart illustrating a flow of the control processing of the continuous imaging, which the lens system 100 illustrated in FIG. 1 executes. As illustrated in FIG. 4, the control processing of the continuous imaging, which the lens system 100 executes, includes control processing S110 of the lens 10 and control processing S120 of the camera 20. The control processing S120 of the camera 20 is processing in which the camera 20 performs continuous imaging. The control processing S110 of the lens 10 is processing in which the lens 10 executes repetitive driving processing and continuous stopping processing in conjunction with the control processing S120 of the camera 20.

### (Control Processing S120 of Camera 20)

The control processing S120 of the camera 20 will be first described. The control processing S120 of the camera 20 is continuous imaging processing, and is processing of continuously imaging still images the scheduled number of times of imaging C_{All} at the exposure time Tₑₓ of one imaging and the interval time Tᵢ between imaging, and of providing a notification to the lens 10 each time exposure has ended.

At step S121, the processor 21 of the camera 20 refers to the fifth setting information SI5, and causes the image sensor 24 to perform exposure during the exposure time Tₑₓ. The processor 21 of the camera 20 acquires a signal that the image sensor 24 has generated through photoelectric conversion, converts the signal into information representing a still image of an image of a subject, and stores the information in the memory 22 of the camera 20.

As illustrated in FIG. 4, the processor 21 of the camera 20 executes step S121 once for each time of a loop from steps S121 to S125. Therefore, the memory 22 of the camera 20 cumulatively stores a piece of information representing one still image for each time of the loop. Therefore, when the control processing S120 of the camera 20 is about to end, the memory 22 of the camera 20 has stored pieces of information representing a set of a C_{All} number of the still images. In other words, when the control processing S120 of the camera 20 is about to end, a set of still images has been generated in the memory 22 of the camera 20.

At step S122, the processor 21 of the camera 20 notifies the processor 11 of the lens 10 that exposure has ended via the mount contact 23 of the camera 20 and the mount contact 14 of the lens 10.

At step S123, the processor 21 of the camera 20 counts up and increments by 1 the cumulative number of times of imaging Cx. When the control processing S120 of the camera 20 is started, Cx=0.

At step S124, the processor 21 of the camera 20 refers to the fifth setting information SI5 and compares the cumulative number of times of imaging Cx with the scheduled number of times of imaging C_{All}. When C_{All}≤Cx (YES), the processor 21 of the camera 20 causes the control processing S120 to end. When C_{All}>Cx (NO), the processor 21 of the camera 20 causes the control processing S120 to proceed to step S125.

At step S125, the processor 21 of the camera 20 refers to the fifth setting information SI5, and waits for the interval time Tᵢ until step S121 starts for a next time. As step S125 is completed, the processor 21 of the camera 20 causes the control processing S120 to return to step S121.

### (Control Processing S110 of Lens 10)

Next, the control processing S110 (a lens control method) of the lens 10 will be described. The control processing S110 of the lens 10 is processing of, in response to the notification from the processor 21 of the camera 20, as illustrated in FIG. 2:
first causing the focus position P to be kept constant at the first focus position P_{A} until the camera 20 performs imaging C₁ times (first continuous stopping processing);
next causing the focus lens 15 to perform driving each time the camera 20 performs imaging to allow the focus position P to change from the first focus position P_{A} to the second focus position P_{B} until the camera 20 performs imaging C₂ times (repetitive driving processing); and
finally causing the focus position P to be kept constant at the second focus position P_{B} until the camera 20 performs imaging (C_{All}−(C₁+C₂)) times (second continuous stopping processing).

At step S111, the processor 11 of the lens 10 refers to the first setting information SI1 to cause the focus lens 15 to perform driving to allow the focus position P to reach the first focus position P_{A}.

At step S112, the processor 11 of the lens 10 waits for a notification that exposure has ended from the processor 21 of the camera 20 while causing the focus lens 15 to be stopped and held and causing the focus position P to be kept constant. As the notification that exposure has ended is received, the processor 11 of the lens 10 causes the control processing S110 to proceed to step S113.

At step S113, the processor 11 of the lens 10 counts up and increments by 1 the cumulative number of times of imaging Cx. When the control processing S110 of the lens 10 is started, Cx=0.

At step S114, the processor 11 of the lens 10 refers to the first setting information SI1 to the fourth setting information SI4 and the cumulative number of times of imaging Cx, and calculates a focus position f(Cx). It means that f(Cx) to be calculated is the focus position P that should have been achieved in advance at Cx-th imaging by the camera 20. The processor 11 of the lens 10 determines an amount of driving between imaging based on a difference between the calculated focus position f(Cx) and the current focus position P (driving amount determination processing).

At step S115, the processor 11 of the lens 10 causes the focus lens 15 to perform driving to achieve the focus position f (Cx) when driving is necessary because the driving amount determined at step S114 is not 0.

At step S116, the processor 11 of the lens 10 refers to the second setting information SI2, the third setting information SI3, and the cumulative number of times of imaging Cx, and compares the cumulative number of times of imaging Cx with C₁+C₂. When Cx<C₁+C₂ (YES), the processor 11 of the lens 10 causes the control processing S110 to return to step S112. When C₁+C₂≤Cx (NO), the processor 11 of the lens 10 causes the control processing S110 to end.

The processor 11 of the lens 10 causes steps S113 to S116 in the processing to be completed during step S125 in the control processing S120 of the camera 20. Therefore, while exposure is performed on the camera 20 side (step S121), the focus position P is kept constant under step S112 in the processing.

As understood from the above description and FIGS. 2 to 4,
when Cx≤C₁ at step S114 (that is, before the repetitive driving processing), the processor 11 of the lens 10 causes the focus lens 15 to be continuously stopped and held during a plurality of times of imaging based on the first setting information SI1 to the fourth setting information SI4. In other words, when Cx≤C₁ at step S114, the processor 11 of the lens 10 executes the first continuous stopping processing.
When C₁<Cx≤C₁+C₂ at step S114, the processor 11 of the lens 10 causes the focus lens 15 to repeat driving between imaging and stopping and holding during imaging based on the first setting information SI1 to the fourth setting information SI4. In other words, when C₁<Cx≤C₁+C₂ at step S114, the processor 11 of the lens 10 executes the repetitive driving processing.
When C₁+C₂<Cx at step S114 (that is, after the repetitive driving processing), the processor 11 of the lens 10 causes the focus lens 15 to be continuously stopped and held during a plurality of times of imaging based on the first setting information SI1 to the fourth setting information SI4. In other words, when C₁+C₂<Cx at step S114, the processor 11 of the lens 10 causes the control processing S110 of the lens 10 to end, and thus skips execution of step S115 and executes the second continuous stopping processing.

In the present embodiment, the processor 11 of the lens 10 executes, while the control processing S110 is under execution, processing of cancelling the control processing S110 in response to an input that the user provides. As an example, when the lens ring 16 and the lens switch 17 receive an input that the user has desired and provided during the control processing S110, the processor 11 of the lens 10 cancels the control processing S110. The processor 11 of the lens 10 notifies the processor 21 of the camera 20 of cancellation of the control processing S110, and the processor 21 of the camera 20 cancels the control processing S120.

### (Storage Processing of Setting Information)

In the present embodiment, the user is allowed to rewrite the first setting information SI1, the second setting information SI2, and the third setting information SI3 using the operation terminal 30. The user is also allowed to rewrite the third setting information SI3 using the lens 10.

On the other hand, in the present embodiment, the fourth setting information SI4 is stored and preset in the memory 12 of the lens 10. The fifth setting information SI5 is stored and preset in the memory 22 of the camera 20. However, the present disclosure is not limited to such a configuration as described above, and each of the fourth setting information SI4 and the fifth setting information SI5 may be rewritable using any one of the lens 10, the camera 20, and the operation terminal 30.

### (Storage Processing S210 Using Lens 10)

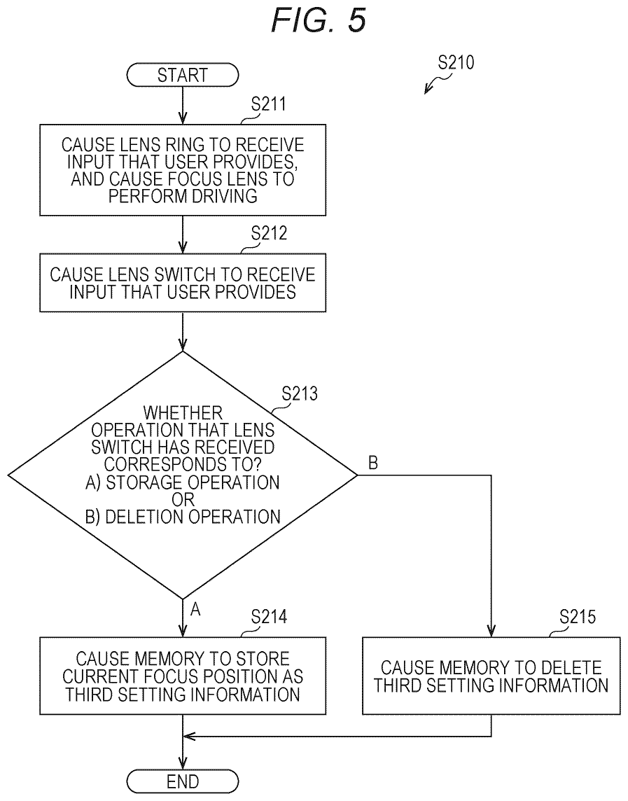

Storage processing S210 using the lens 10 will be described with reference to FIG. 5. FIG. 5 is a flowchart illustrating a flow of the storage processing S210 using the lens 10 illustrated in FIG. 1.

At step S211, the processor 11 of the lens 10 causes the lens ring 16 to receive an input that the user provides (an operation of causing the lens ring 16 to rotate). The processor 11 of the lens 10 causes the focus lens 15 to perform driving in accordance with an amount of the rotation and a direction of the rotation of the lens ring 16. With step S211, the focus position P that the user desires to be stored in the memory 12 as third setting information is achieved.

At step S212, the processor 11 of the lens 10 causes the lens switch 17 to receive an input that the user provides (an operation of pressing down the lens switch 17).

At step S213, the processor 11 of the lens 10 determines a type of the operation that the lens switch 17 has received at step S212. When the received operation is a storage operation (A), the processor 11 of the lens 10 causes the storage processing S210 to proceed to step S214. When the received operation is a deletion operation (B), the processor 11 of the lens 10 causes the storage processing S210 to proceed to step S215. Although a long-pressing operation of the lens switch 17 is assigned as the storage operation, and a double-clicking operation of the lens switch 17 is assigned as the deletion operation in the present embodiment, it is possible to assign desired operations as the storage operation and the deletion operation in the present disclosure. As an example, instead of the double-clicking operation, a single-clicking operation of the lens switch 17 may be assigned as the deletion operation. Furthermore, a plurality of types of deletion operations may be adopted, and each of the deletion operations may be associated with deletion of any one of two or more focus positions included in the third setting information SI3. As an example, a single-clicking operation may be associated with deletion of the first focus position P_{A}, and a double-clicking operation may be associated with deletion of both the first focus position P_{A} and the second focus position P_{B}.

At step S214, the processor 11 of the lens 10 causes the memory 12 of the lens 10 to store the current focus position P as the third setting information SI3 based on the storage operation that the lens switch 17 has received. In the present embodiment, the first focus position P_{A} and the second focus position P_{B} are stored in the memory 12 in this order. When the first focus position P_{A} and the second focus position P_{B} are already stored in the memory 12, the processor 11 causes step S214 to end without newly storing the third setting information SI3 in the memory 12. However, the present disclosure is not limited to such a configuration as described above, and it is possible to desirably design control that takes place at step S214.

At step S215, the processor 11 of the lens 10 causes the memory of the lens 10 to delete the third setting information SI3 that has currently been stored.

### (Storage Processing S230 Using Operation Terminal 30)

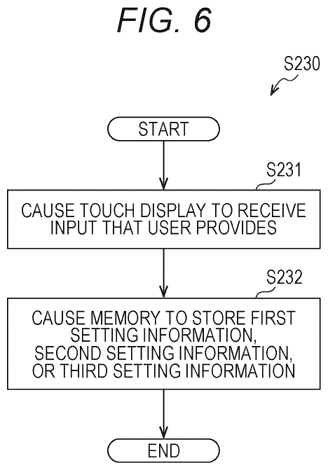

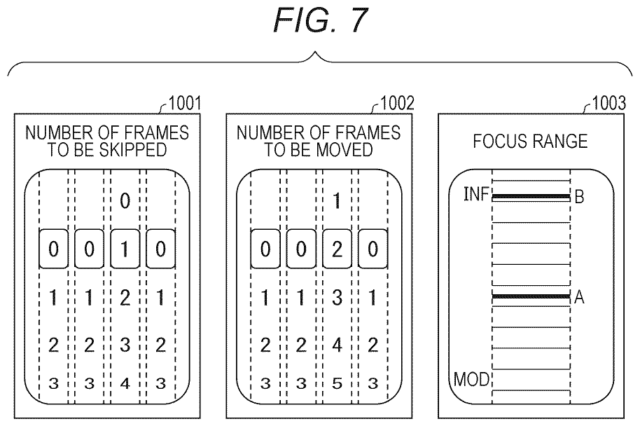

Storage processing S230 of the first setting information SI1 to the third setting information SI3 will be described with reference to FIGS. 6 and 7. FIG. 6 is a flowchart illustrating a flow of the storage processing S230 of the first setting information SI1, the second setting information SI2, and the third setting information SI3 using the operation terminal 30 illustrated in FIG. 1. FIG. 7 is a schematic diagram illustrating screens 1001, 1002, and 1003 that the touch display 34 illustrated in FIG. 1 displays in the storage processing S230 illustrated in FIG. 6.

At step S231, the processor 31 of the operation terminal 30 causes the touch display 34 to receive an input (a touch operation) that the user provides. At step S231, as illustrated in FIG. 7, the touch display 34 displays the screen 1001 imitating a slot reel for receiving an input of a 4-digit numerical value as the first setting information SI1. The touch display 34 displays the screen 1002 imitating a slot reel for receiving an input of a 4-digit numerical value as the second setting information SI2. The touch display 34 displays the screen 1003 imitating a peripheral side surface of the lens ring for receiving the third setting information SI3. On the screen 1003, the user is allowed to desirably generate, delete, and move a bar A corresponding to the first focus position P_{A} and a bar B corresponding to the second focus position P_{B} within a range from a proximal-most end (MOD) to an infinity end (INF) of a focus range. The processor 31 of the operation terminal 30 causes the touch display 34 to switch and display the screen 1001, the screen 1002, and the screen 1003 in accordance with an input that the user provides.

At step S232, the processor 31 of the operation terminal 30 transmits the first setting information SI1 to the third setting information SI3 to the processor 11 of the lens 10 via the communication interface 33 of the operation terminal 30 and the communication interface 13 of the lens 10. The processor 11 of the lens 10 stores the first setting information SI1 to the third setting information SI3 that have been received in the memory 12 of the lens 10.

### MODIFICATION EXAMPLES OF FIRST EMBODIMENT

### Modification Example Regarding Hardware Configuring Lens System

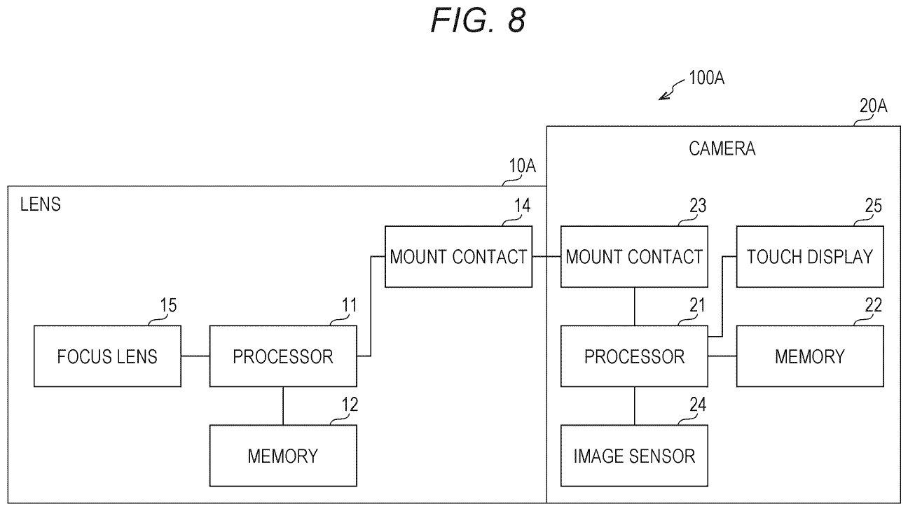

Hardware configuring the lens system is not limited to hardware illustrated in FIG. 1. A modification example regarding hardware will be described with reference to FIG. 8.

FIG. 8 is a block diagram illustrating a configuration of a lens system 100A according to a modification example of the first embodiment of the present disclosure. As illustrated in FIG. 8, the lens system 100A according to the modification example includes a lens 10A and a camera 20A. In the modification example illustrated in FIG. 8, the lens 10A is different from the lens 10 illustrated in FIG. 1 in that the communication interface 13 that mediates communications with the operation terminal 30, the lens ring 16 that receives an input that the user provides, and the lens switch 17 are not included. Furthermore, the camera 20A is different from the camera 20 illustrated in FIG. 1 in that a touch display 25 is further included on a back surface, which is provided as an input unit.

In the modification example illustrated in FIG. 8, the user is allowed to use the camera 20A to rewrite the first setting information SI1 to the fifth setting information SI5, which are all stored in the memory 22 of the camera 20A. The processor 21 of the camera 20A causes the touch display 25 to receive an input that the user provides, and causes the memory 22 of the camera 20A to store various types of setting information.

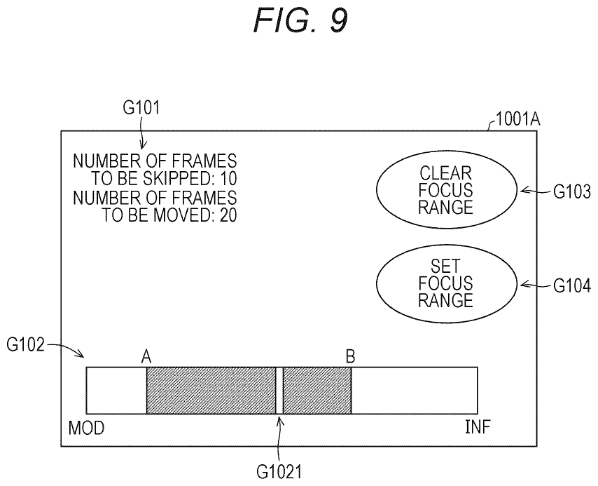

Those that the touch display 25 displays will be described with reference to FIG. 9. FIG. 9 is a schematic diagram illustrating a screen 1001A that the touch display 25 illustrated in FIG. 8 displays. As illustrated in FIG. 9, the screen 1001A includes a graphic G101, a graphic G102, a graphic G103, and a graphic G104. The graphic G101 displays the first setting information SI1 and the second setting information SI2 stored in the memory 22. When the graphic G101 is touched, the processor 21 of the camera 20A separately displays a screen for allowing the user to input the first setting information SI1 and the second setting information SI2. The graphic G101 displays, as the third setting information SI3 stored in the memory 22, a range of the first focus position P_{A} and the second focus position P_{B} within a range from the proximal-most end (MOD) to the infinity end (INF) of the focus range. The graphic G102 includes a graphic G1021 as a current focus position being displayed. When the graphic G103 is touched, the processor 21 of the camera 20A causes the memory 22 to delete the third setting information SI3 being currently stored. When the graphic G104 is touched, the processor 21 of the camera 20A separately displays a screen for allowing the user to input the third setting information SI3.

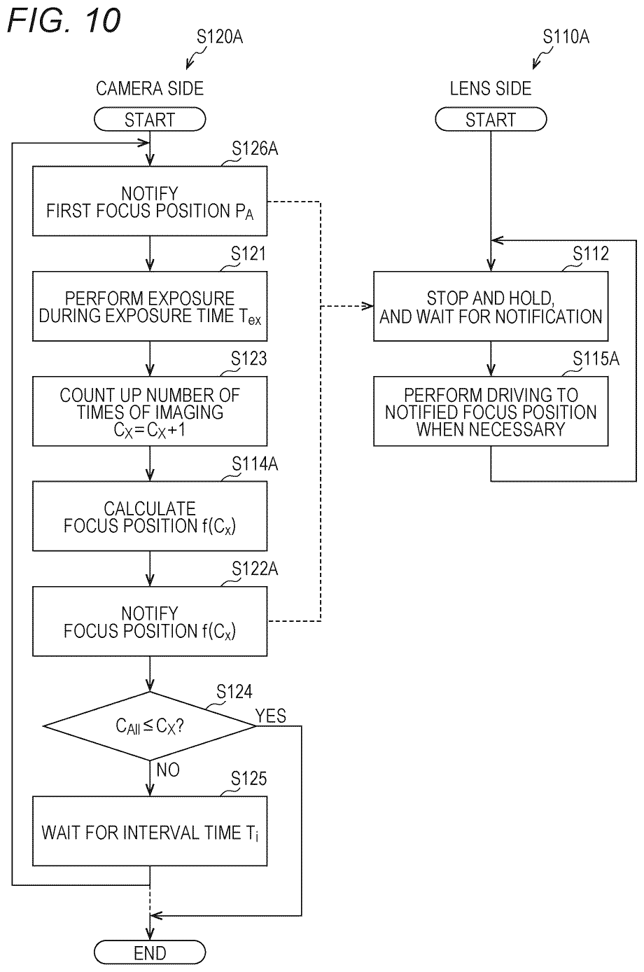

Control processing of continuous imaging, which the lens system 100A illustrated in FIG. 8 executes, will be described with reference to FIG. 10. FIG. 10 is a flowchart illustrating a flow of the control processing of the continuous imaging, which the lens system 100A illustrated in FIG. 8 executes.

In control processing S120A of the camera 20A, the processor 21 of the camera 20A executes the control processing of the camera 20A based on the first setting information SI1 to the fifth setting information SI5 stored in the memory 22. The control processing S120A of the camera 20A and control processing S110A of the lens 10A are different from the control processing illustrated in FIG. 4 mainly in points described below.
When the control processing S120A is started, at step S126A, the processor 21 of the camera 20A first refers to the third setting information SI3 to notify the processor 11 of the lens 10A of the first focus position P_{A}. At step S115A, the processor 11 of the lens 10A, which has received the notification, causes the focus lens 15 to perform driving to allow the focus position P to reach the first focus position P_{A} that has been notified.
The processor 21 of the camera 20A refers to the first setting information SI1 to the fourth setting information SI4, and executes, immediately after step S123, a step in the processing (step S114A), which is identical to step S114 illustrated in FIG. 4.
The processor 21 of the camera 20A notifies the processor 11 of the lens 10 of a calculated focus position f(Cx) at step S122A. At step S115A, the processor 11 of the lens 10A, which has received the notification, causes the focus lens 15 to perform driving to allow the focus position P to reach the focus position f(Cx) that has been notified.
The processor 11 of the lens 10 does not execute steps S111, S113, S114, and S116.

### Modification Example Regarding Number of Times of Imaging, Period of Time of Imaging, and Driving of Lens Optical System

In the present embodiment, the relationship between the cumulative number of times of imaging Cx and the focus position P is defined by the function f, and, as illustrated in FIG. 2, the function f defines that the continuous stopping processing is executed both before and after the repetitive driving processing. However, the present disclosure is not limited to such a configuration as described above, and it is possible to desirably set the function f within a range in which the continuous stopping processing is executed at least either before or after the repetitive driving processing.

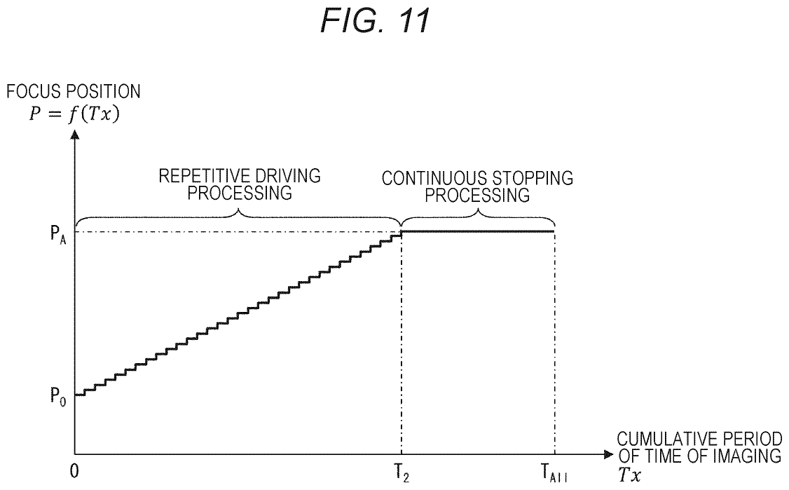

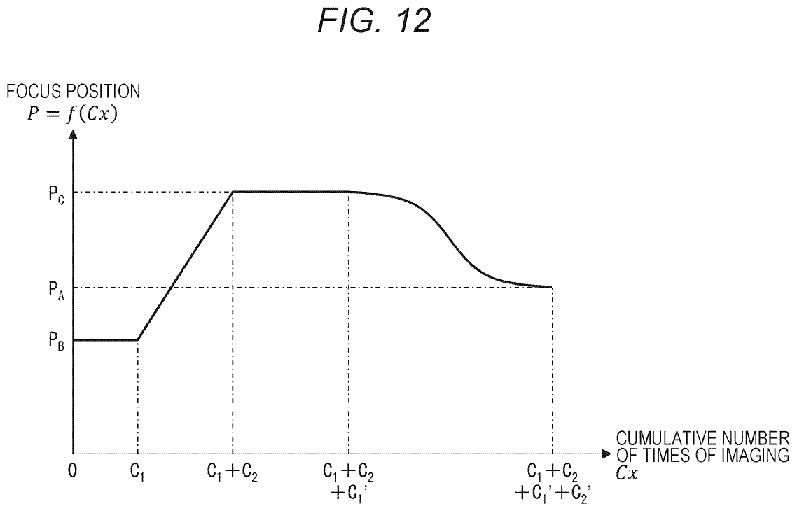

The modification example of the relationship between the cumulative number of times of imaging Cx or a cumulative period of time of imaging Tx and the focus position P will be described with reference to FIGS. 11 and 12.

FIG. 11 is a graph illustrating a modification example of the relationship between the cumulative number of times of imaging and the focus position in the continuous imaging illustrated in FIG. 3. In the modification example illustrated in FIG. 11, the focus position P at the start time point of the continuous imaging is a desired focus position P₀ such as the focus position P at the start time point of the control processing S110 of the lens 10. That is, step S111 illustrated in FIG. 4 is not executed. However, the present disclosure is not limited to such a configuration as described above, and the focus position P at the start time point may be selected from the focus positions included in the third setting information SI3 through a desired method. For example, at step S111, the processor 11 may select any focus position from the focus position P at the start time point among the focus positions included in the third setting information SI3, and may cause the focus lens 15 to perform driving to achieve the selected focus position. The selection of a focus position may be executed based on a difference from the focus position P at the start time point, and, for example, a focus position at which a difference is smallest or largest may be selected.

In the modification example illustrated in FIG. 11, the continuous stopping processing is not executed before the repetitive driving processing, and the continuous stopping processing is executed only after the repetitive driving processing. However, the present disclosure is not limited to such a configuration as described above, and the continuous stopping processing may be executed only before the repetitive driving processing, or the repetitive driving processing and the continuous stopping processing may be alternately repeated two or more times.

In the modification example illustrated in FIG. 11, the cumulative period of time of imaging Tx is adopted as an explanatory variable of the function f, duration T₂ of the repetitive driving processing is adopted as the second setting information SI2, and a scheduled period of time of imaging T_{All} is adopted as the fifth setting information SI5.

In the modification example illustrated in FIG. 11, the first setting information SI1 is unnecessary. Furthermore, in still another modification example in which an order of the repetitive driving processing and the continuous stopping processing is exchanged, the second setting information SI2 is unnecessary.

FIG. 12 is a graph illustrating a modification example of the relationship between the cumulative number of times of imaging and the focus position in the continuous imaging illustrated in FIG. 3. In the modification example illustrated in FIG. 12, the repetitive driving processing to be performed twice in total and the continuous stopping processing to be performed twice in total are alternately executed. In each processing, the number of times of imaging is separately set, the first setting information SI1 includes the numbers of times C₁ and C₁′, and the second setting information SI2 includes the numbers of times C₂ and C₂′. The third setting information SI3 includes three focus positions P_{A}, P_{B}, and P_{C}. The processor 11 of the lens 10 executes the repetitive driving processing two or more times with the continuous stopping processing interposed to allow the focus position P to change in an order of the focus positions P_{B}, P_{C}, and P_{A} in accordance with the definition based on the function f. However, in the present disclosure, the number of focus positions included in the third setting information SI3 is not particularly limited, and may be four or more. The repetitive driving processing may be executed three or more times to allow a focus position included in the third setting information SI3 to be achieved. Furthermore, it is possible to desirably set an order with which a focus position included in the third setting information SI3 is achieved.

In the modification example illustrated in FIG. 12, in the repetitive driving processing for the second time, a change in the focus position P is non-linear with respect to a change in the cumulative number of times of imaging Cx, and each focus position P between imaging is not constant. Such a non-linear change in the focus position P is defined by the function f.

### Modification Example Regarding Determination of Driving Amount

In the present embodiment, as illustrated in FIG. 4, a determination of a driving amount by the lens 10 is executed (S114) each time the camera 20 performs imaging (step S121). However, the present disclosure is not limited to such a configuration as described above. The processor 11 of the lens 10 may collectively calculate a focus position f(Cx) with respect to all the cumulative numbers of times of imaging Cx within a range of 1≤Cx≤C_{All} immediately after the start of the control processing S110 of the lens 10. At this time, the processor 11 of the lens 10 may collectively determine a driving amount for each Cx based on a difference between a certain focus position f(Cx) and a focus position f(Cx−1) in the previous imaging.

### Second Embodiment

Hereinafter, another embodiment of the present disclosure will be described. In addition, for convenience of description, members having the same functions as the members in the above-described embodiment are denoted by the same reference numerals, and description thereof will not be repeated.

### (Lens System 600)

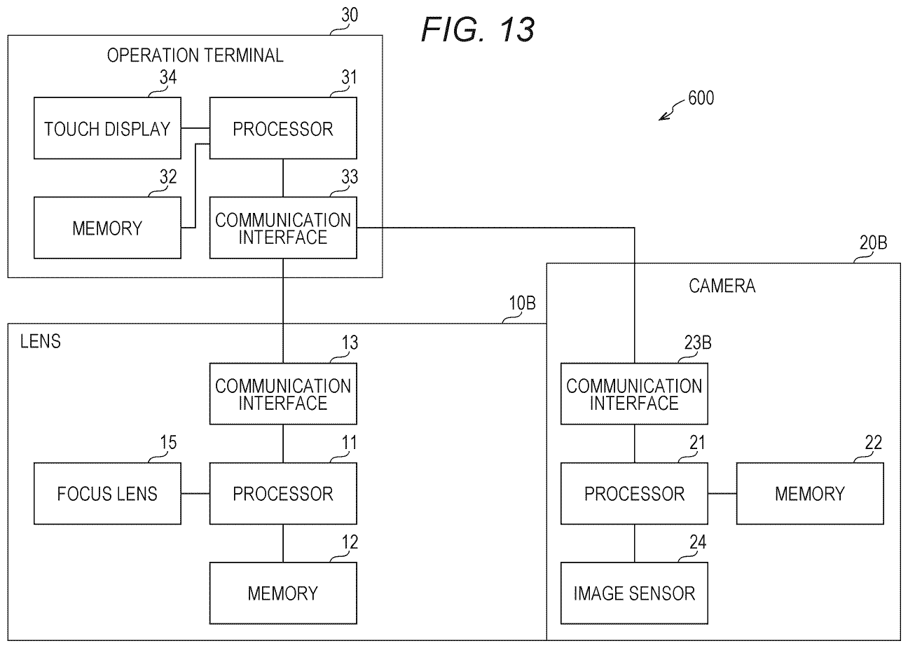

A configuration of a lens system 600 according to a second embodiment of the present disclosure will be described with reference to FIG. 13. FIG. 13 is a block diagram illustrating the configuration of the lens system 600 according to the second embodiment of the present disclosure. The lens system 600 is a system for controlling a lens optical system for continuous imaging in which imaging is performed a plurality of times.

As illustrated in FIG. 13, the lens system 600 includes a lens 10B, a camera 20B, and the operation terminal 30. The lens 10B and the operation terminal 30 are communicably coupled to each other using a USB cable via a communication interface 13 of the lens 10B and the communication interface 33 of the operation terminal 30. The camera 20B and the operation terminal 30 are communicably coupled to each other using a USB cable via a communication interface 23B of the camera 20B and the communication interface 33 of the operation terminal 30.

Note that methods of communications between the camera 20B and the operation terminal 30 in the present disclosure are not limited to those described above, and it is possible to adopt desired methods of communications, which enable electric communications. As an example, the camera 20B and the operation terminal 30 may be coupled to each other with a release cable. In this case, a terminal for the release cable may be adopted as each of the communication interface 23B of the camera 20B and the communication interface 33 of the operation terminal 30.

### (Lens 10B)

The lens 10B is a configuration for forming an image of a subject on an image sensor 24 that the camera 20B includes. In the present embodiment, a lens barrel detachably attached to the camera 20B is adopted as the lens 10B. As illustrated in FIG. 13, the lens 10B includes a processor 11, a memory 12, the communication interface 13, and a focus lens 15.

### (Camera 20B)

The camera 20B is provided as an imaging unit, and is a configuration for converting the image of the subject, which has been formed on the image sensor 24, into an image. In the present embodiment, a camera body of a digital camera is adopted as the camera 20B. As illustrated in FIG. 13, the camera 20B includes a processor 21, a memory 22, the communication interface 23B, and the image sensor 24.

The communication interface 23B is a configuration for controlling transmission and reception of various types of information from the camera 20B and by the camera 20B. In the present embodiment, a USB interface is adopted as the communication interface 23B.

### (Operation Terminal 30)

The operation terminal 30 is a configuration for receiving an input that the user provides, regarding various types of information that the lens system 600 refers to. In the present embodiment, a smartphone is adopted as the operation terminal 30. As illustrated in FIG. 13, the operation terminal 30 is separated from the lens 10B, and includes the processor 31, the memory 32, the communication interface 33, and the touch display 34.

### (Outline of Continuous Imaging)

Since, in the present embodiment, a relationship between a cumulative number of times of imaging Cx and a focus position P in continuous imaging is identical to that in the graph illustrated in FIG. 1 for describing the first embodiment, its detailed description will be omitted.

In the present embodiment, first setting information SI1, second setting information SI2, third setting information SI3, and fourth setting information SI4 serving as setting information regarding imaging conditions are stored in the memory 12 of the lens 10B and referred to by the processor 11 of the lens 10B. As the setting information regarding the imaging conditions, an exposure time Tₑₓ in fifth setting information SI5 is stored in the memory 22 of the camera 20B and is referred to by the processor 21 of the camera 20B. As the setting information regarding the imaging conditions, a scheduled number of times of imaging Can in the fifth setting information SI5 is stored in the memory 32 of the operation terminal 30 and is referred to by the processor 31 of the operation terminal 30.

### (Control Processing of Continuous Imaging)

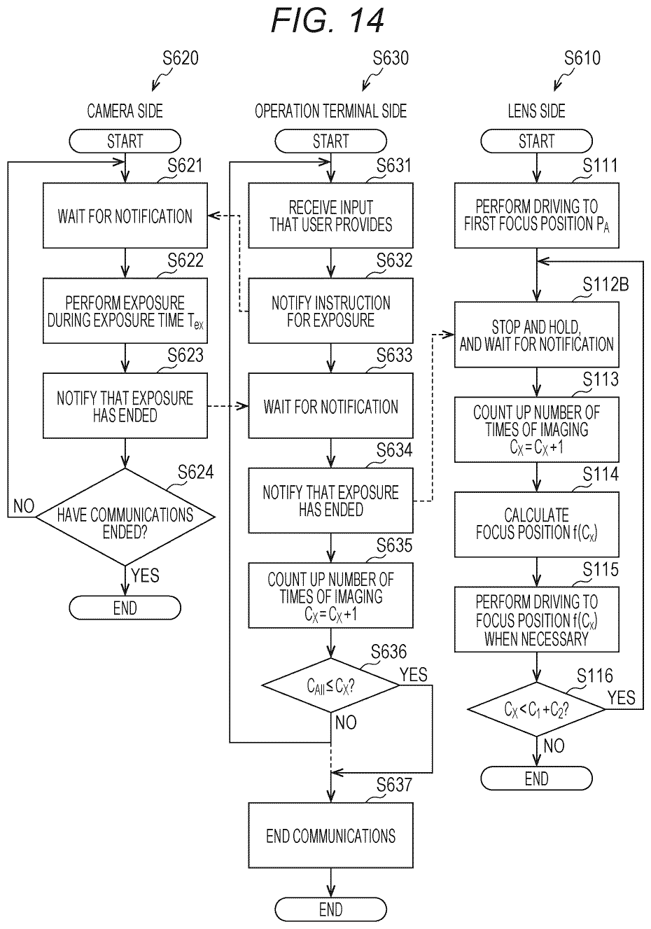

Details of control processing of continuous imaging will be described with reference to FIG. 14. FIG. 14 is a flowchart illustrating a flow of the control processing of the continuous imaging, which the lens system illustrated in FIG. 13 executes. As illustrated in FIG. 14, the control processing of the continuous imaging, which the lens system 600 executes, includes control processing S610 of the lens 10B, control processing S620 of the camera 20B, and control processing S630 of the operation terminal 30. The control processing S620 of the camera 20B is processing in which the camera 20B performs continuous imaging in conjunction with the control processing S630 of the operation terminal 30. The control processing S610 of the lens 10B is processing in which the lens 10B executes repetitive driving processing and continuous stopping processing in conjunction with the control processing S620 of the camera 20B and the control processing S630 of the operation terminal 30. The control processing S630 of the operation terminal 30 is processing of notifying the lens 10B and the camera 20B of an instruction in response to an input that the user provides.

### (Control Processing S630 of Operation Terminal 30)

The control processing S630 of the operation terminal 30 will first be described. The control processing S630 of the operation terminal 30 is processing of instructing the camera 20B to perform exposure and notifying the lens 10B of a driving amount necessary to reach a next focus position for next imaging each time an input that the user provides is received.

At step S631, the processor 31 of the operation terminal 30 causes the touch display 34 to receive an input (a touch operation on a graphic for instructing imaging) that the user provides. The processor 31 of the operation terminal 30 waits until the touch display 34 receives the input. When the touch display 34 receives the input, the processor 31 of the operation terminal 30 causes the control processing S630 to proceed to step S632.

Note that, although, in the present embodiment, an input that the user provides is adopted as a trigger for causing the control processing S630 to proceed to step S632, the present disclosure is not limited to such a configuration as described above. As an example, elapse of a predetermined interval time may be adopted as a trigger. In this case, the interval time is stored in the memory 32 of the operation terminal 30 and is referred to by the processor 31 of the operation terminal 30. Alternatively, a combination of an input that the user provides and elapse of a predetermined interval time may be adopted as a trigger. In this case, the processor 31 of the operation terminal 30 may also wait for an input that the user provides while waiting for elapse of the interval time, and the processor 31 may cause the control processing S630 to proceed to step S632 when one or both of them occurs or occur.

At step S632, the processor 31 of the operation terminal 30 notifies the processor 21 of the camera 20B of an instruction of causing the image sensor 24 to perform exposure.

At step S633, the processor 31 of the operation terminal 30 waits for the notification from the processor 21 of the camera 20B at step S623. As the notification is received, the processor 31 of the operation terminal 30 causes the control processing S630 to proceed to step S634.

Note that, although, in the present embodiment, a notification from the processor 21 of the camera 20B is adopted as a trigger for causing the control processing S630 to proceed to step S634, the present disclosure is not limited to such a configuration as described above. As an example, elapse of a predetermined exposure time may be adopted as a trigger. In this case, the exposure time is stored in the memory 32 of the operation terminal 30 and is referred to by the processor 31 of the operation terminal 30. In this case, at step S633, the processor 31 of the operation terminal 30 may wait for elapse of the exposure time, and, after elapse of the exposure time, the processor 31 may cause the control processing S630 to proceed to step S634.

At step S634, the processor 31 of the operation terminal 30 notifies the processor 11 of the lens 10B that the exposure by the camera 20B has ended.

At step S635, the processor 31 of the operation terminal 30 counts up and increments by 1 the cumulative number of times of imaging Cx. When the control processing S630 of the operation terminal 30 is started, Cx=0.

At step S636, the processor 31 of the operation terminal 30 refers to the fifth setting information SI5 and compares the cumulative number of times of imaging Cx with the scheduled number of times of imaging C_{All}. When C_{All}≤Cx (YES), the processor 31 of the operation terminal 30 causes the control processing S630 to proceed to step S637. When C_{All}>Cx (NO), the processor 31 of the operation terminal 30 causes the control processing S630 to return to step S631.

At step S637, the processor 31 of the operation terminal 30 causes the communications with the processor 21 of the camera 20B to end. As step S637 is completed, the processor 31 of the operation terminal 30 causes the control processing S630 to end.

### (Control Processing S620 of Camera 20B)

Next, the control processing S620 of the camera 20B will be described. The control processing S120 of the camera 20 is continuous imaging processing, and is processing of performing exposure once and providing the operation terminal 30 of a notification each time the exposure has ended based on an instruction notified from the operation terminal 30 in response to an input that the user provides.

At step S621, the processor 21 of the camera 20B waits for the notification from the processor 31 of the operation terminal 30 at step S633. As the notification is received, the processor 21 of the camera 20B causes the control processing S620 to proceed to step S622.

At step S622, the processor 21 of the camera 20B causes the image sensor 24 to perform exposure based on the notification received from the processor 31 of the operation terminal 30. Note herein that the processor 21 of the camera 20B refers to the exposure time Tₑₓ in the fifth setting information SI5, and sets the exposure time Tₑₓ. The processor 21 of the camera 20B acquires a signal that the image sensor 24 has generated through photoelectric conversion, converts the signal into information representing a still image of an image of a subject, and stores the information in the memory 22 of the camera 20B.

At step S623, the processor 21 of the camera 20B notifies the processor 31 of the operation terminal 30 that the exposure has ended.

At step S624, the processor 21 of the camera 20B determines whether or not the communications with the processor 31 of the operation terminal 30 have ended. When the communications have ended (YES), the processor 21 of the camera 20B causes the control processing S620 to end. When the communications are continued (NO), the processor 21 of the camera 20B causes the control processing S620 to return to step S621.

### (Control Processing S610 of Lens 10B)

Next, the control processing S610 of the lens 10B will be described. The control processing S610 of the lens 10B is processing of, based on an instruction notified from the operation terminal 30 in response to an input that the user provides:
first causing the focus position P to be kept constant at the first focus position P_{A} until the camera 20B performs imaging C₁ times (first continuous stopping processing);
next causing the focus lens 15 to perform driving each time the camera 20B performs imaging to allow the focus position P to change from the first focus position P_{A} to the second focus position P_{B} until the camera 20B performs imaging C₂ times (repetitive driving processing); and
finally causing the focus position P to be kept constant at the second focus position P_{B} until the camera 20B performs imaging (C_{All}−(C₁+C₂)) times (second continuous stopping processing).

The control processing S610 of the lens 10B is identical to the control processing S110 of the lens 10 illustrated in FIG. 4 except that the processor 11 of the lens 10B executes step S112B of waiting for the notification that exposure has ended from the operation terminal 30B, instead of step S112 of waiting for the notification that exposure has ended from the camera 20.

As understood from the above description and FIG. 14, in the present embodiment, the user is allowed to input an operation on the touch display 34 at a desired time point, and to cause the camera 20B and the lens 10B to execute each processing corresponding to one exposure each time such an input is provided.

### SUMMARY

As understood from the above description, the present disclosure includes the following aspects.

Aspect 1: A lens system (100, 100A, 600) for generating a set of still images through continuous imaging in which imaging of still images is repeated, the lens system including: a lens optical system (15); at least one memory (12, 22, 32) that stores setting information regarding imaging conditions; and at least one processor (11, 21, 31), in which the at least one processor executes, in the continuous imaging: repetitive driving processing of causing the lens optical system to repeat driving between imaging and stopping and holding during imaging based on the setting information; and continuous stopping processing of causing the lens optical system to continue stopping and holding during a plurality of times of imaging based on the setting information at least either before or after the repetitive driving processing. According to the present aspect of the present disclosure, a new imaging technique for generating a set of still images is provided. In the present aspect, the repetitive driving processing in which imaging is performed a plurality of times while driving of the lens optical system occurs and a state changes and the continuous stopping processing in which imaging is performed a plurality of times while the state of the lens optical system is kept constant before or after the repetitive driving processing are combined with each other. According to this combination, for example, it is possible to produce:
a time-lapse moving image in which the line of sight is focused on a main subject (for example, a focused subject or a subject located at the center of an angle of view) in the continuous stopping processing, making it possible to guide the line of sight; and
a creative multiple exposure photograph in which a main subject in the continuous stopping processing and a secondary subject (for example, a moving object in the background) in the repetitive driving processing appear in one still image.

Aspect 2: The lens system according to Aspect 1, in which the setting information includes first setting information (SI1) regarding a number of times of imaging in the continuous stopping processing or duration of the continuous stopping processing, and the at least one processor executes the continuous stopping processing based on the first setting information. According to the present aspect, where imaging is performed while the state of the lens optical system is kept constant until it is satisfied the number of times of imaging or the duration stored as the first setting information, a set of still images captured in the continuous stopping processing exerts an effect of focusing the line of sight at intensity in accordance with the number of times or the duration.

Aspect 3: The lens system according to Aspect 1 or 2, in which the setting information includes second setting information (SI2) regarding a number of times of imaging in the repetitive driving processing or duration of the repetitive driving processing, and the at least one processor executes the repetitive driving processing based on the second setting information. According to the present aspect, where imaging is performed while the state of the lens optical system changes until it is satisfied the number of times of imaging or the duration stored as the second setting information, a set of still images captured in the repetitive driving processing exerts an effect of moving the line of sight at intensity in accordance with the number of times or the duration.

Aspect 4: The lens system according to any one of Aspects 1 to 3, in which the setting information includes third setting information (SI3) regarding a state of the lens optical system at at least either a start time point or an end time point of the repetitive driving processing, and the at least one processor executes the repetitive driving processing and the continuous stopping processing based on the third setting information. According to the present aspect, the at least one processor is allowed to determine the state of the lens optical system when the repetitive driving processing is started or ended based on the third setting information. In other words, according to the present aspect, it is possible to appropriately set an amount of change and a direction of the change of the lens optical system in the repetitive driving processing. In the related art, a camera that performs continuous imaging while changing a focus position for aiming at depth synthesis imaging is known. However, for such a camera, its operation is often limited where, until the focus position reaches an infinity end (INF), the focus position is continuously driven in a direction to the INF. According to the present aspect, it is possible to appropriately set how far and in which direction the state of the lens optical system is to be changed.

Aspect 5: The lens system according to Aspect 4, in which the third setting information represents three or more states of the lens optical systems, and the at least one processor executes the repetitive driving processing two or more times with the continuous stopping processing interposed to allow the lens optical system to sequentially take the three or more states of the lens optical system based on the third setting information. According to the present aspect, it is possible to achieve continuous imaging through three or more lens optical systems, making it possible to produce more complicated moving images and still images.

Aspect 6: The lens system according to any one of Aspects 1 to 5, in which the setting information includes: second setting information (SI2) regarding a number of times of imaging in the repetitive driving processing or duration of the repetitive driving processing; and third setting information (SI3) regarding a state of the lens optical system at at least either a start time point or an end time point of the repetitive driving processing, and the at least one processor executes driving amount determination processing (step S114, step S114A, step S637) of determining an amount at which the lens optical system performs driving between imaging in the repetitive driving processing based on the second setting information and the third setting information. According to the present aspect, where a driving amount is determined based on the continuation conditions of the repetitive driving processing and the state of the lens optical system at the start time point or the end time point of the repetitive driving processing, it is possible to more complicatedly adjust an amount of change of the lens optical system for each imaging.

Aspect 7: The lens system according to any one of Aspects 1 to 6, further including an imaging unit (20, 20A, 20B) on an optical axis of the lens optical system, in which the at least one processor further executes continuous imaging processing of causing the imaging unit to perform continuous imaging, and executes the repetitive driving processing and the continuous stopping processing in conjunction with the continuous imaging processing. According to the present aspect, where the continuous imaging by the imaging unit and driving of the lens optical system are executed in conjunction with each other, an operation that the user performs for the continuous imaging becomes simpler.

Aspect 8: The lens system according to any one of Aspects 1 to 7, further including an input unit (17, 25, 34) that receives an input that a user provides, in which the at least one processor further executes storage processing (step S214, step S232) of causing the memory to store the setting information based on an input that the input unit receives. According to the present aspect, it is possible to store setting information that the user desires in the memory in accordance with a scene, and it is possible to achieve continuous imaging closer to the continuous imaging that the user desires.

Aspect 9: The lens system according to any one of Aspects 1 to 8, the lens system being used for time-lapse imaging. According to the present aspect, it is possible that:
the continuous stopping processing in which imaging is performed while the state of the lens optical system is kept constant allows the line of sight to be focused on a main subject in the constant state; and
the repetitive driving processing before the continuous stopping processing allows the line of sight to be gradually focused on the main subject, or the repetitive driving processing after the continuous stopping processing allows the line of sight focused on through the continuous stopping processing to be guided. Therefore, the lens system according to the present aspect is suitable for producing a time-lapse moving image that is excellent in guiding the line of sight.

Aspect 10: A lens control method for generating a set of still images through continuous imaging in which imaging of still images is repeated, the lens control method including, in a lens system including: a lens optical system; at least one memory that stores setting information regarding imaging conditions; and at least one processor, allowing the at least one processor to execute, in the continuous imaging: repetitive driving processing of causing the lens optical system to repeat driving between imaging and stopping and holding during imaging based on the setting information; and continuous stopping processing of causing the lens optical system to continue stopping and holding during a plurality of times of imaging based on the setting information at least either before or after the repetitive driving processing. According to the present aspect of the present disclosure, a new imaging technique for generating a set of still images is provided.

Aspect 11: A lens control program (P10, P20, P30) for controlling a lens system for generating a set of still images through continuous imaging in which imaging of still images is repeated, the lens system including: a lens optical system; at least one memory that stores setting information regarding imaging conditions; and at least one processor, the lens control program allowing the at least one processor to execute, in the continuous imaging: repetitive driving processing of causing the lens optical system to repeat driving between imaging and stopping and holding during imaging based on the setting information; and continuous stopping processing of causing the lens optical system to continue stopping and holding during a plurality of times of imaging based on the setting information at least either before or after the repetitive driving processing. According to the present aspect of the present disclosure, a new imaging technique for generating a set of still images is provided.

### SUPPLEMENTARY NOTE

The present invention is not limited to the above-described embodiments, but can be modified in various ways within the scope of the claims. Embodiments obtained by appropriately combining technical means disclosed in different embodiments are also included in the technical scope of the present invention.

What is claimed is:

1. A lens system for generating a set of still images through continuous imaging in which imaging of still images is repeated, the lens system comprising:
a lens optical system;
at least one memory that stores setting information regarding imaging conditions; and
at least one processor,
wherein the at least one processor executes, in the continuous imaging:
repetitive driving processing of causing the lens optical system to repeat driving between imaging and stopping and holding during imaging based on the setting information; and
continuous stopping processing of causing the lens optical system to continue stopping and holding during a plurality of times of imaging based on the setting information at least either before or after the repetitive driving processing.

2. The lens system according to claim 1, wherein
the setting information includes first setting information regarding a number of times of imaging in the continuous stopping processing or duration of the continuous stopping processing, and
the at least one processor executes the continuous stopping processing based on the first setting information.

3. The lens system according to claim 1, wherein
the setting information includes second setting information regarding a number of times of imaging in the repetitive driving processing or duration of the repetitive driving processing, and
the at least one processor executes the repetitive driving processing based on the second setting information.

4. The lens system according to claim 1, wherein
the setting information includes third setting information regarding a state of the lens optical system at at least either a start time point or an end time point of the repetitive driving processing, and
the at least one processor executes the repetitive driving processing and the continuous stopping processing based on the third setting information.

5. The lens system according to claim 4, wherein
the third setting information represents three or more states of the lens optical systems, and
the at least one processor executes the repetitive driving processing two or more times with the continuous stopping processing interposed to allow the lens optical system to sequentially take the three or more states of the lens optical system based on the third setting information.

6. The lens system according to claim 1, wherein
the setting information includes: second setting information regarding a number of times of imaging in the repetitive driving processing or duration of the repetitive driving processing; and third setting information regarding a state of the lens optical system at at least either a start time point or an end time point of the repetitive driving processing, and
the at least one processor executes driving amount determination processing of determining an amount at which the lens optical system performs driving between imaging in the repetitive driving processing based on the second setting information and the third setting information.

7. The lens system according to claim 1,
further comprising an imaging unit on an optical axis of the lens optical system,
wherein the at least one processor
further executes continuous imaging processing of causing the imaging unit to perform continuous imaging, and
executes the repetitive driving processing and the continuous stopping processing in conjunction with the continuous imaging processing.

8. The lens system according to claim 1,
further comprising an input unit that receives an input that a user provides,
wherein the at least one processor further executes storage processing of causing the memory to store the setting information based on an input that the input unit receives.

9. The lens system according to claim 1, the lens system being used for time-lapse imaging.

10. A lens control method for generating a set of still images through continuous imaging in which imaging of still images is repeated, the lens control method comprising, in a lens system including: a lens optical system; at least one memory that stores setting information regarding imaging conditions; and at least one processor, allowing the at least one processor to execute, in the continuous imaging:
repetitive driving processing of causing the lens optical system to repeat driving between imaging and stopping and holding during imaging based on the setting information; and
continuous stopping processing of causing the lens optical system to continue stopping and holding during a plurality of times of imaging based on the setting information at least either before or after the repetitive driving processing.

11. A lens control program for controlling a lens system for generating a set of still images through continuous imaging in which imaging of still images is repeated, the lens system including: a lens optical system; at least one memory that stores setting information regarding imaging conditions; and at least one processor, the lens control program allowing the at least one processor to execute, in the continuous imaging:
repetitive driving processing of causing the lens optical system to repeat driving between imaging and stopping and holding during imaging based on the setting information; and
continuous stopping processing of causing the lens optical system to continue stopping and holding during a plurality of times of imaging based on the setting information at least either before or after the repetitive driving processing.
